(19) United States
(12) Patent Application Publication
(10) Pub. No.: US 2026/0223965 A1
(43) Pub. Date: Aug. 6, 2026

(54) WEARABLE DEVICE

(71) Applicant: Toyota Jidosha Kabushiki Kaisha, Toyota-shi (JP)

(72) Inventor: Tomohiro TSUBOTA, Nagoya-shi (JP)

(73) Assignee: Toyota Jidosha Kabushiki Kaisha, Toyota-shi (JP)

(21) Appl. No.: 19/400,251

(22) Filed: Nov. 25, 2025

(30) Foreign Application Priority Data
Jan. 29, 2025 (JP) 2025-013163

(51) Int. Cl. A41D 19/00

(52) U.S. Cl. CPC A41D 19/0024; A41D 19/001

(57) ABSTRACT

A wearable device includes a base portion that is mounted on a body and that has a base material layer formed of an elastomer, an electronic device disposed on the base material layer, and a conductive thread that is sewn to the base material layer and that is electrically connected to the electronic device. The base portion has a portion in which a cover layer formed of an elastomer that covers the electronic device disposed on the base material layer is provided and a portion in which the cover layer is not provided.

### CROSS-REFERENCE TO RELATED APPLICATION

This application claims priority to Japanese Patent Application No. 2025-013163 filed on January 29, 2025. The disclosure of the above-identified application, including the specification, drawings, and claims, is incorporated by reference herein in its entirety.

### BACKGROUND

### Technical Field

The present disclosure relates to a wearable device.

### Description of Related Art

A wearable device that is worn on a body is known (for example, Japanese Unexamined Patent Application Publication No. 2023-167572 (JP 2023-167572 A)).

### SUMMARY

Since the wearable device in the related art has a structure in which a sensor, an insulating cable, or the like is incorporated between the inner and the outer, the thickness of the wearable device is large, and it may be difficult to move the body when the wearable device is worn. Therefore, it is desired to reduce the thickness of the wearable device.

The present disclosure can be implemented as the following aspects.

(1) According to an aspect of the present disclosure, a wearable device is provided. The wearable device includes:

a base portion worn on a body and including a base material layer made of an elastomer,

an electronic device disposed on the base material layer, and

a conductive thread sewn to the base material layer and electrically connected to the electronic device.

The base portion includes a portion in which a cover layer made of an elastomer is provided to cover the electronic device disposed on the base material layer, and a portion in which the cover layer is not provided.

With the wearable device according to the aspect, since the electronic device and the conductive thread are incorporated in one base portion, and the base portion includes the portion in which the cover layer is not provided on the base material layer, the thickness of the wearable device can be reduced.

(2) In the wearable device according to the aspect,

the base portion may include a portion in which a coating layer is provided to cover the conductive thread sewn to the base material layer.

With the wearable device according to the aspect, the conductive thread can be protected by the coating layer.

(3) In the wearable device according to the aspect,

the base portion may include a portion in which neither the cover layer nor the coating layer is provided on the base material layer.

With the wearable device according to the aspect, since the base portion includes the portion in which neither the cover layer nor the coating layer is provided on the base material layer, the thickness of the wearable device can be reduced.

(4) In the wearable device according to the aspect,

the base portion may have a glove shape, and may be worn on a hand.

With the wearable device according to the aspect, it is possible to provide a thin wearable device that facilitates movement of the fingers.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram showing a configuration of a wearable device;

FIG. 2 is an explanatory diagram showing a disposition of a sensor, an input-side conductive thread, and an output-side conductive thread; and

FIG. 3 is a cross-sectional view of the wearable device.

### DETAILED DESCRIPTION OF EMBODIMENTS

### A. Embodiment:

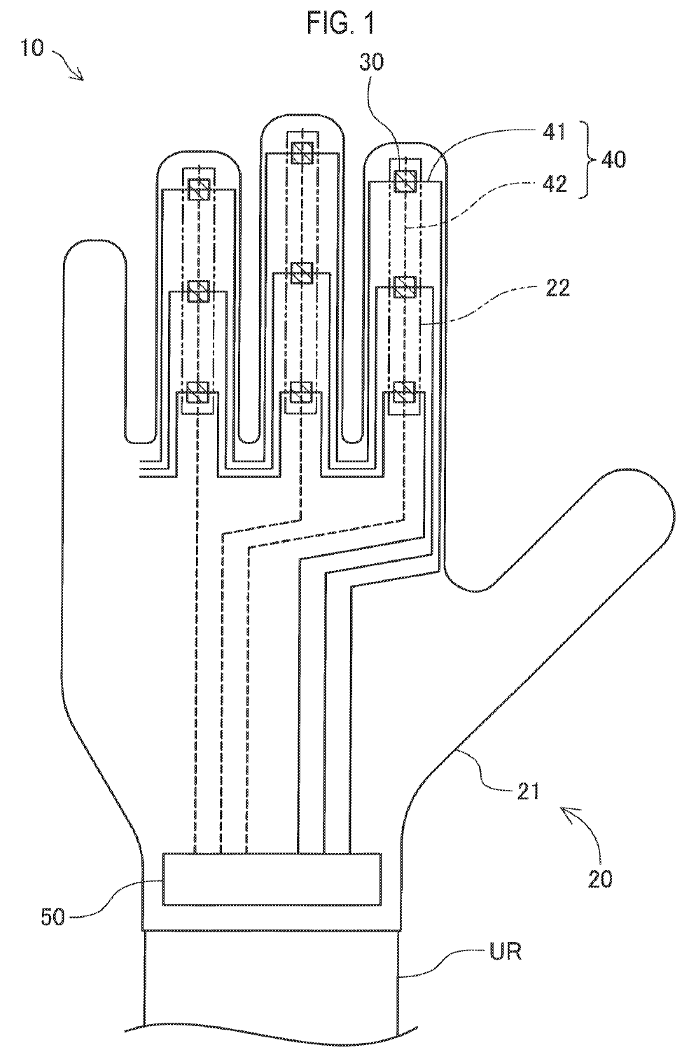

FIG. 1 is an explanatory diagram showing a configuration of a wearable device 10 as an embodiment of the present disclosure. The wearable device 10 is used in a state of being mounted on a human body. In the present embodiment, the wearable device 10 is mounted on a hand of a user UR and is used to detect a pressure applied to the hand of the user UR. In FIG. 1, a palm side of the wearable device 10 is shown.

The wearable device 10 includes a base portion 20, a plurality of sensors 30, a plurality of conductive threads 40, and a controller 50. In the present disclosure, the sensor 30 may be referred to as an electronic device.

The base portion 20 is mounted on the hand of the user UR. The base portion 20 has a base material layer 21, a cover layer 22, and a coating layer 23 (see FIG. 3). In the present embodiment, the base material layer 21 is configured in a glove shape and covers a portion from a distal end of a finger of the user UR to a wrist. The base material layer 21 is configured to cover each finger. The cover layer 22 is provided to cover the sensor 30, and the coating layer 23 is provided to cover the conductive thread 40. The base material layer 21, the cover layer 22, and the coating layer 23 are formed of an elastomer having insulating properties. In the present embodiment, the base material layer 21, the cover layer 22, and the coating layer 23 are formed of silicone rubber. However, one of the base material layers 21, the cover layer 22, or the coating layer 23 may be formed of a material different from the other two, or all of the base material layer 21, the cover layer 22, and the coating layer 23 may be formed of different materials.

The plurality of sensors 30 is fixed to the base material layer 21. In the present embodiment, each sensor 30 is fixed to the base material layer 21 on the palm side. In the present embodiment, the number of sensors 30 is nine. The nine sensors 30 are disposed three each in a thumb portion, a middle finger portion, and a ring finger portion of the base material layer 21. However, the number of sensors 30 is not limited to the above-described number, and may be, for example, eight or less or ten or more. The disposition of the sensor 30 is not limited to the above-described disposition, and, for example, the sensor 30 may be disposed on all of the five finger portions, or the sensor 30 may be disposed on a palm portion or a back of hand portion. In the present embodiment, each sensor 30 is a pressure sensor. Each sensor 30 is composed of a pressure-sensitive conductive sheet. As the pressure-sensitive conductive sheet, for example, Velostat can be used. The electrical resistance of the pressure-sensitive conductive sheet changes according to the pressure. Therefore, the pressure applied to each part of the finger can be detected based on the output voltage of each sensor 30.

The plurality of conductive threads 40 is sewn to the base material layer 21. The conductive thread 40 is a thread having conductivity. In the present embodiment, each conductive thread 40 is composed of a fiber bundle of nylon fiber and a silver-plated layer covering the fiber bundle. Each conductive thread 40 does not have an insulating coating. In the present embodiment, each conductive thread 40 is sewn to the base material layer 21 by a sewing machine. However, each conductive thread 40 may be sewn to the base portion 20 by hand instead of a sewing machine. Each conductive thread 40 is electrically connected to the sensor 30 and the controller 50 and transmits and receives an electric signal between the sensor 30 and the controller 50.

The plurality of conductive threads 40 includes an input-side conductive thread 41 that is electrically connected to an output terminal of the controller 50 and one surface of the sensor 30. The plurality of conductive threads 40 includes an output-side conductive thread 42 that is electrically connected to the other surface of the sensor 30 and an input terminal of the controller 50. In FIG. 1, the input-side conductive thread 41 is represented by a solid line, and the output-side conductive thread 42 is represented by a broken line.

In the present embodiment, the number of input-side conductive threads 41 is three. One of the three input-side conductive threads 41 is electrically connected to the three sensors 30 disposed at distal ends of the thumb, the middle finger, and the ring finger. The other input-side conductive thread 41 of the three input-side conductive threads 41 is electrically connected to the three sensors 30 disposed at middle portions of the thumb, the middle finger, and the ring finger. The remaining input-side conductive thread 41 of the three input-side conductive threads 41 is electrically connected to the three sensors 30 disposed at base ends of the thumb, the middle finger, and the ring finger.

The number of output-side conductive threads 42 is three. One of the three output-side conductive threads 42 is electrically connected to the three sensors 30 disposed in the thumb portion. The other output-side conductive thread 42 of the three output-side conductive threads 42 is electrically connected to the three sensors 30 disposed in the middle finger portion. The remaining output-side conductive thread 42 of the three output-side conductive threads 42 is electrically connected to the three sensors 30 disposed in the ring finger portion.

The controller 50 is fixed to, for example, a wrist portion of the base material layer 21. In the present embodiment, the controller 50 includes a battery that applies a voltage to each sensor 30, a circuit board that processes the electric signal output from each sensor 30, and the like. The controller 50 may further include a communication device for transmitting the detection result of each sensor 30 to the outside.

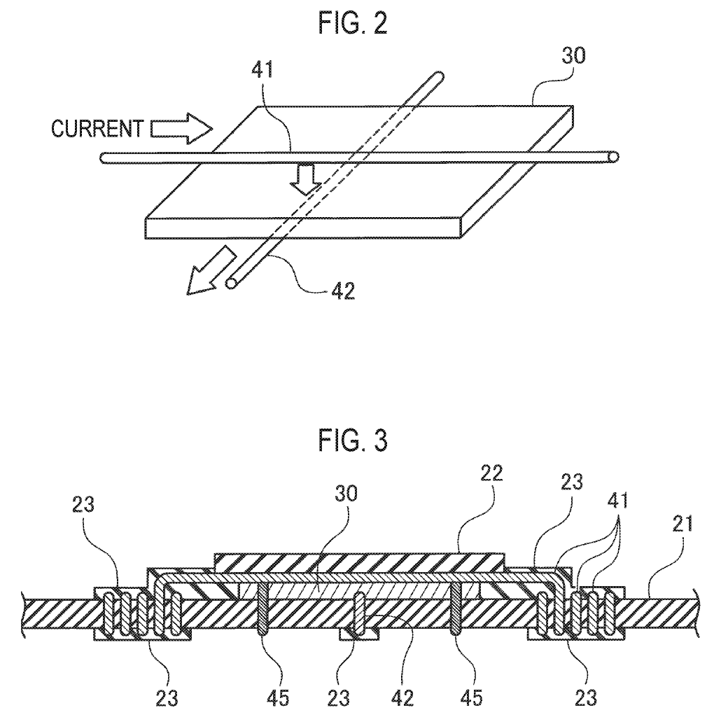

FIG. 2 is an explanatory diagram showing a disposition of the sensor 30, the input-side conductive thread 41, and the output-side conductive thread 42. The sensor 30 is configured in a flat plate shape. The input-side conductive thread 41 is electrically connected to one surface of the sensor 30, and the output-side conductive thread 42 is electrically connected to the other surface of the sensor 30. The input-side conductive thread 41 and the output-side conductive thread 42 are disposed to be perpendicular to the sensor 30 and to intersect perpendicularly. A current supplied from the output terminal of the controller 50 flows in the order of the input-side conductive thread 41, the sensor 30, the output-side conductive thread 42, and the input terminal of the controller 50. The controller 50 applies a voltage to the nine sensors 30 in order and measures the output voltage of the nine sensors 30 in order. The electrical resistance of the sensor 30 changes according to the pressure applied to the sensor 30. In other words, the output voltage of the sensor 30 changes according to the pressure applied to the sensor 30. The controller 50 detects the pressure applied to each sensor 30 based on a measurement result of the output voltage of each sensor 30.

In the present embodiment, first, the controller 50 applies a voltage to the input-side conductive thread 41 connected to the three sensors 30 disposed at the distal ends of the thumb, the middle finger, and the ring finger. The controller 50 measures the output voltage of the three sensors 30 in the order of the thumb portion, the middle finger portion, and the ring finger portion via the three output-side conductive threads 42 connected to the three sensors 30. Next, the controller 50 applies a voltage to the input-side conductive thread 41 connected to the three sensors 30 disposed at the middle portions of the thumb, the middle finger, and the ring finger. The controller 50 measures the output voltage of the three sensors 30 in the order of the thumb portion, the middle finger portion, and the ring finger portion via the three output-side conductive threads 42 connected to the three sensors 30. Thereafter, the controller 50 applies a voltage to the input-side conductive thread 41 connected to the three sensors 30 disposed at the base ends of the thumb, the middle finger, and the ring finger. The controller 50 measures the output voltage of the three sensors 30 in the order of the thumb portion, the middle finger portion, and the ring finger portion via the three output-side conductive threads 42 connected to the three sensors 30. The controller 50 switches the sensor 30 that measures the output voltage from the nine sensors 30 at, for example, 50Hz. In this way, the controller 50 can acquire the output voltage of the nine sensors 30.

FIG. 3 is a cross-sectional view of the wearable device 10. The base portion 20 has the base material layer 21, the cover layer 22, and the coating layer 23. The sensor 30 is disposed on the base material layer 21. In the present embodiment, the sensor 30 is fixed to the base material layer 21 by being sewn to the base material layer 21 by an insulating thread 45. The insulating thread 45 is a thread having insulating properties. The insulating thread 45 is composed of, for example, a fiber bundle of insulating fibers such as natural fibers such as cotton, chemical fibers such as nylon fibers, or blended fibers including natural fibers and chemical fibers. The insulating thread 45 does not have a metal plating layer or an insulating coating. The insulating thread 45 may be sewn to the base material layer 21 by a sewing machine or may be sewn to the base material layer 21 by hand. The input-side conductive thread 41 and the output-side conductive thread 42 are sewn to the base material layer 21. In the present embodiment, the thickness of the base material layer 21 is the same at all portions. However, the thickness of the base material layer 21 may be different for each portion.

The base material layer 21 may be manufactured in a plurality of parts. For example, the base material layer 21 may be manufactured in a palm side part and a back of hand side part. The palm side part and the back of hand side part can be manufactured using an injection molding machine or a 3D printer. It is preferable that the palm side part is flat plate-shaped so that the conductive thread 40 is easily sewn by a sewing machine. After the conductive thread 40 is sewn to the palm side part, the adhesive portions provided on the palm side part and the back of hand side part are butted and heated to integrate the two parts, thereby obtaining the base material layer 21 to which the conductive thread 40 is sewn. It is preferable that the excess adhesive portion is cut and removed.

The cover layer 22 is provided to cover the sensor 30 disposed on the base material layer 21. The cover layer 22 is formed by bonding a sheet-shaped member to the base material layer 21 on which the sensor 30 is disposed. The cover layer 22 is provided only in a portion in which the sensor 30 is disposed. In other words, the base portion 20 has a portion in which the cover layer 22 is provided on the base material layer 21 and a portion in which the cover layer 22 is not provided on the base material layer 21. From the viewpoint of reducing the thickness of the base portion 20, it is preferable that the thickness of the cover layer 22 is thinner than the thickness of the base material layer 21. In the present embodiment, the thickness of the cover layer 22 is the same at all portions. However, the thickness of the cover layer 22 may be different for each portion.

A part of the coating layer 23 is provided to cover the input-side conductive thread 41 sewn to the base material layer 21. The remaining part of the coating layer 23 is provided to cover the output-side conductive thread 42 sewn to the base material layer 21. The coating layer 23 is formed by coating the base material layer 21 to which the input-side conductive thread 41 and the output-side conductive thread 42 are sewn. The coating layer 23 is provided only in a portion in which the input-side conductive thread 41 or the output-side conductive thread 42 is disposed. In other words, the base portion 20 has a portion in which the coating layer 23 is provided on the base material layer 21 and a portion in which the coating layer 23 is not provided on the base material layer 21. The base portion 20 has a portion in which neither the cover layer 22 nor the coating layer 23 is provided on the base material layer 21, in other words, a portion in which the front surface and the back surface of the base material layer 21 are exposed. In the present embodiment, the thickness of the coating layer 23 on the conductive thread 40 is thinner than the thickness of the base material layer 21 and thinner than the thickness of the cover layer 22.

According to the wearable device 10 in the present embodiment described above, the sensor 30 and the conductive thread 40 are incorporated in one base portion 20. Therefore, the base portion 20 is composed of two of the inner and the outer. The configuration of the wearable device 10 can be simplified, and the wearable device 10 can be reduced in thickness as compared with an aspect in which the sensor 30 or the insulating cable is incorporated between the inner and the outer. In particular, in the present embodiment, the conductive thread 40 having no insulating coating is used instead of the insulating cable having the insulating coating in order to transmit and receive the electric signal of the sensor 30. Therefore, the wearable device 10 can be reduced in thickness as compared with an aspect in which the insulating cable is used.

In addition, in the present embodiment, the base portion 20 has a portion in which the cover layer 22 is not provided on the base material layer 21. Therefore, the wearable device 10 can be reduced in thickness as compared with an aspect in which the entire base portion 20 is composed of two layers of the base material layer 21 and the cover layer 22.

In addition, in the present embodiment, the conductive thread 40 sewn to the base material layer 21 of the base portion 20 is covered with the coating layer 23. Therefore, the conductive thread 40 can be protected from friction and the like by the coating layer 23.

In addition, in the present embodiment, the base portion 20 has a portion in which neither the cover layer 22 nor the coating layer 23 is provided on the base material layer 21. Therefore, the wearable device 10 can be reduced in thickness as compared with an aspect in which the entire base portion 20 is composed of two or more layers by providing the cover layer 22 or the coating layer 23 on the entire base material layer 21.

In addition, in a case where the wearable device 10 is a glove type mounted on a hand, in a case where the thickness is large, it is difficult to move the finger, so that the mounting feeling and the workability are deteriorated. On the other hand, in the present embodiment, since the wearable device 10 is reduced in thickness, a wearable device 10 having a good mounting feeling and workability can be provided.

In addition, in the present embodiment, the base material layer 21, the cover layer 22, and the coating layer 23 of the base portion 20 are formed of silicone rubber. Therefore, the water resistance and the rust resistance of the portion in which the sensor 30 is disposed and the portion in which the conductive thread 40 is sewn are ensured. Therefore, in the present embodiment, the wearable device 10 can be washed with water.

### B. Other Embodiments:

(B1) The wearable device 10 of each of the above-described embodiments includes the sensor 30 that detects the pressure applied to the hand. On the other hand, the wearable device 10 may include another sensor instead of the sensor 30 that detects the pressure applied to the hand or in addition to the sensor 30. The wearable device 10 may include, as another sensor, for example, an acceleration sensor that detects an acceleration of the hand, a gyro sensor that detects an angular velocity of the hand, a bending sensor that detects a bending state of the finger, or the like. In addition, the wearable device 10 may include an electronic device such as an LED, a speaker, or an actuator instead of the sensor 30 or in addition to the sensor 30.

(B2) In the wearable device 10 of the above-described embodiment, the base portion 20 is configured in a glove type mounted on a hand. On the other hand, the base portion 20 may be configured as, for example, an arm band type mounted on an arm, a sock type mounted on a leg, or a head band type mounted on a head.

(B3) The wearable device 10 of the above-described embodiment includes a plurality of sensors 30 and a plurality of conductive threads 40. On the other hand, the number of sensors 30 included in the wearable device 10 may be one, and the number of conductive threads 40 included in the wearable device 10 may be one.

(B4) In the wearable device 10 of the above-described embodiment, the sensor 30 that detects the pressure is composed of a pressure-sensitive conductive sheet whose electrical resistance changes according to the pressure. On the other hand, the sensor 30 that detects the pressure may be composed of a material whose electrostatic capacity changes according to the pressure.

(B5) In the wearable device 10 of the above-described embodiment, the base portion 20 includes the coating layer 23 that covers the conductive thread 40. On the other hand, the base portion 20 may not include the coating layer 23.

(B6) The wearable device 10 of the above-described embodiment includes the controller 50. On the other hand, the wearable device 10 may be configured to be separate from the controller 50.

(B7) The wearable device 10 of the above-described embodiment is used in a state of being mounted on a human body. On the other hand, the wearable device 10 may be used in a state of being mounted on a body of a humanoid robot.

The present disclosure is not limited to the above-described embodiments and can be implemented with various configurations without departing from the gist of the present disclosure. For example, the technical features in the embodiments corresponding to the technical features in the respective forms described in SUMMARY can be replaced or combined as appropriate to solve a part or all of the above-described objects, or to achieve a part or all of the above-described effects. In a case where the technical features are not described as being always needed in the present specification, the features can be deleted as appropriate.

What is claimed is:

1. A wearable device comprising:
a base portion worn on a body and including a base material layer made of an elastomer;
an electronic device disposed on the base material layer; and
a conductive thread sewn to the base material layer and electrically connected to the electronic device,
wherein the base portion includes a portion in which a cover layer made of an elastomer is provided to cover the electronic device disposed on the base material layer, and a portion in which the cover layer is not provided.

2. The wearable device according to claim 1, wherein the base portion includes a portion in which a coating layer is provided to cover the conductive thread sewn to the base material layer.

3. The wearable device according to claim 2, wherein the base portion includes a portion in which neither the cover layer nor the coating layer is provided on the base material layer.

4. The wearable device according to claim 1, wherein the base portion has a glove shape, and is worn on a hand.
